(19) United States
(12) Patent Application Publication
(10) Pub. No.: US 2016/0125500 A1
(43) Pub. Date: May 5, 2016

(54) PROFIT MAXIMIZATION RECOMMENDER SYSTEM FOR RETAIL BUSINESSES

(71) Applicants: Mengjiao WANG, Shanghai (CN); Yu CHENG, Shanghai (CN); Wen-Syan LI, Fremont, CA (US)

(72) Inventors: Mengjiao WANG, Shanghai (CN); Yu CHENG, Shanghai (CN); Wen-Syan LI, Fremont, CA (US)

(21) Appl. No.: 14/528,763

(22) Filed: Oct. 30, 2014

(51) Int. Cl. G06Q 30/06; G06F 17/30; G06Q 40/00

(52) U.S. Cl. CPC G06Q 30/0631; G06Q 40/12; G06F 17/30386

(57) ABSTRACT

A method includes receiving an identification code for an item selected for purchase by a customer in a retail store, identifying at least one item similar to the customer-selected item, identifying at least one item related to the customer-selected item, calculating a value for a first expected profit for a first sale of the customer-selected item and the similar item, calculating a value for a second expected profit for a second sale of the customer-selected item and the related item, sorting the first sale and the second sale in an order based on the value for the first expected profit and the value for the second expected profit, and providing information associated with the first sale and the second sale, the information for use in recommending the similar item or the related item for purchase by the customer in the retail store.

### TECHNICAL FIELD

This description relates to cross-selling and up-selling to a customer in a retail store.

### BACKGROUND

Traditional retail stores (retailers) continue to look for ways to improve profit and revenue when selling items (goods or products) to customers. For example, cross-selling and up-selling can be ways a retailer can improve profits and revenue. Cross-selling can recommend items that are similar or related to an item the customer is interested in buying in the hope that the customer will purchase the additional item. Up-selling can recommend one or more items to a customer that are more expensive than the item the customer originally planned to purchase, in hopes that the customer will choose to buy the more expensive item.

In some situations, the retailer can hire skilled assistants that can make product recommendations to customers. The skilled assistants can have experience with the product and the retailer's systems and businesses. A retail store, however, can inventory thousands of items where the price of each item can change daily, making it difficult for the assistant to make an appropriate recommendation to a customer. In addition, hiring skilled assistants can be difficult and expensive.

A retailer is faced with the challenge of having an efficient, easy to use, and cost-effective mechanism for an assistant (or retail associate) to provide an appropriate recommendation to a customer that fulfills the customer's needs and requirements while maximizing the retailer's profits and revenue. Having a mechanism that helps an assistant provide appropriate cross-selling and upselling recommendations to customers can result in having satisfied customers and a happy retailer.

### SUMMARY

According to one general aspect, a method includes receiving an identification code for an item selected for purchase by a customer in a retail store, identifying at least one item similar to the customer-selected item, identifying at least one item related to the customer-selected item, calculating a value for a first expected profit for a first sale of the customer-selected item and the similar item, calculating a value for a second expected profit for a second sale of the customer-selected item and the related item, sorting the first sale and the second sale in an order based on the value for the first expected profit and the value for the second expected profit, and providing, for display on a display device of a portable computing device, information associated with the first sale and the second sale in a manner representative of the sorted order of the first sale and the second sale, the information for use in recommending the similar item or the related item for purchase by the customer in the retail store.

Implementations may include one or more of the following features. For example, identifying at least one item similar to the customer-selected item can include identifying at least one feature associated with the similar item that is the same as at least one feature associated with the customer-selected item. Identifying at least one item similar to the customer-selected item can include calculating a value representative of the similarity between the at least one similar item and the customer-selected item. Identifying at least one item similar to the customer-selected item further can include determining that the calculated value representative of the similarity between the at least one similar item and the customer-selected item meets or exceeds a threshold value. Calculating a value representative of the similarity between the at least one similar item and the customer-selected item can include calculating one of a cosine similarity, a squared Euclidean distance, and a Jaccard index. Identifying the at least one item related to the customer-selected item can include following an association rule mining algorithm that determines a value for a support factor and a value for a confidence factor for a relationship between a candidate item and the customer-selected item. Identifying the at least one item related to the customer-selected item can further include, based on determining that the value for the support factor meets or exceeds a threshold value, identifying the candidate item as the at least one item related to the customer-selected item. Identifying the at least one item related to the customer-selected item can further include, based on determining that the value for the support factor meets or exceeds a first threshold value and based on determining that the value for the confidence factor meets or exceeds a second threshold value, identifying the candidate item as the at least one item related to the customer-selected item. Calculating a value for a first expected profit for a first sale of the customer-selected item and the similar item can include determining a value associated with a probability that the customer will purchase the similar item based on the selection of the customer-selected item for purchase by the customer. The calculated value for the first expected profit can be based on an expected profit associated with the sale of the customer-selected item, an expected profit associated with the sale of the similar item, and the value associated with the probability that the customer will purchase the similar item. Calculating a value for a second expected profit for a second sale of the customer-selected item and the related item can include determining a value associated with a probability that the customer will purchase the related item based on the selection of the customer-selected item for purchase by the customer. The calculated value for the second expected profit can be based on an expected profit associated with the sale of the customer-selected item, an expected profit associated with the sale of the related item, and the value associated with the probability that the customer will purchase the related item. The sorted order can be a descending order of the value for the first expected profit and the value for the second expected profit.

In another general aspect, a system includes a portable computing device including a display device, a recommendation system including a candidate item generation module, an association rule mining module, and a maximum profit recommendation module, and means for entering identification data for association with an item. The means for entering identification data for association with an item include means for entering an identification code for an item selected for purchase by a customer in a retail store. The candidate item generation module is configured to identify at least one item similar to the customer-selected item. The association rule mining module is configured to identify at least one item related to the customer-selected item. The maximum profit recommendation module is configured to calculate a value for a first expected profit for a first sale of the customer-selected item and the similar item, calculate a value for a second expected profit for a second sale of the customer-selected item and the related item, and sort the first sale and the second sale in an order based on the value for the first expected profit and the value of the second expected profit. The display device is configured to display information associated with the first sale and the second sale in a manner representative of the sorted order of the first sale and the second sale.

Implementations may include one or more of the following features. For example, identifying at least one item similar to the customer-selected item can include the candidate item generation module being configured to access a plurality of records for items available for sale by a retailer, calculate a value representative of a similarity between a record for a candidate item and a record for the customer-selected item, and identify the candidate item as the similar item based on determining that the calculated value meets or exceeds a threshold value. Identifying at least one item related to the customer-selected item can include the association rule mining module being configured to access a plurality of records for items available for sale by a retailer, calculate a value for a support factor and a value for a confidence factor for a relationship between a record for a candidate item and a record for the customer-selected item, and identify the candidate item as the related item based on determining that the calculated value for the support factor meets or exceeds a first threshold value and that the calculated value for the confidence factor meets or exceeds a second threshold value. Calculating a value for a first expected profit for a first sale of the customer-selected item and the similar item can include the maximum profit recommendation module being configured to determine a value associated with a probability that the customer will purchase the similar item based on the selection of the customer-selected item for purchase by the customer. The calculated value for the first expected profit can be based on an expected profit associated with the sale of the customer-selected item, an expected profit associated with the sale of the similar item, and the value associated with the probability that the customer will purchase the similar item. Calculating a value for a second expected profit for a second sale of the customer-selected item and the related item can include the maximum profit recommendation module being configured to determine a value associated with a probability that the customer will purchase the related item based on the selection of the customer-selected item for purchase by the customer. The calculated value for the second expected profit can be based on an expected profit associated with the sale of the customer-selected item, an expected profit associated with the sale of the related item, and the value associated with the probability that the customer will purchase the related item. The portable computing device can further include a bar code scanner. The means for entering identification data can include the bar code scanner. The portable computing device can further include a keyboard. The means for entering identification data can include the keyboard.

In yet another general aspect, a computer program product is tangibly embodied on a non-transitory computer-readable storage medium and includes instructions that, when executed by at least one computing device, are configured to cause the at least one computing device to receive an identification code for an item selected for purchase by a customer in a retail store, identify at least one item similar to the customer-selected item, identify at least one item related to the customer-selected item, calculate a value for a first expected profit for a first sale of the customer-selected item and the similar item, calculate a value for a second expected profit for a second sale of the customer-selected item and the related item, sort the first sale and the second sale in descending order based on the value for the first expected profit and the value for the second expected profit, and provide for display on a display device included in the at least one computing device, information associated with the first sale and the second sale in a manner representative of the sorted order of the first sale and the second sale, the information for use in recommending the similar item or the related item for purchase by the customer in the retail store.

Implementations may include one or more of the following features. For example, the instructions that are configured to cause the at least one computing device to identify at least one item similar to the customer-selected item can include instructions that are configured to cause the at least one computing device to identify at least one feature associated with the similar item that is the same as at least one feature associated with the customer-selected item, calculate a value representative of the similarity between the at least one similar item and the customer-selected item, and determine that the calculated value representative of the similarity between the at least one similar item and the customer-selected item meets or exceeds a threshold value.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram of an example system that includes a recommendation system installed on a centralized computer system.

FIG. 2 is a diagram of an example system that includes a recommendation system installed on a computer system.

FIG. 3 is a diagram of an example system that includes a copy of a recommendation system installed on multiple computing devices.

FIG. 4A is a diagram showing a 2D bar code included on an item.

FIG. 4B is a diagram showing a 3D bar code included on an item.

FIG. 4C is a diagram showing a product identification included on an item.

FIG. 5 is an illustration of an example computing device that shows appropriate recommendations for up-selling or cross-selling to a customer.

FIG. 6 is an illustration showing modules that are included in a recommendation system.

FIG. 7 is a flowchart that illustrates a method for identifying cross-selling and/or upselling recommendations.

The details of one or more implementations are set forth in the accompanying drawings and the description below. Other features will be apparent from the description and drawings, and from the claims.

### DETAILED DESCRIPTION

This document describes recommendation systems and techniques for use by an assistant (a sales assistant, a sales associate, a store assistant, or a shopping assistant) in a retail store (a retail location) that can help the assistant make recommendations to customers. In some implementations, the recommendation system can be installed on a portable computing device of an assistant. Examples of the computing device can include, but are not limited to, a laptop computer, a notebook computer, a tablet, a mobile phone, a smartphone, or a personal digital assistant. In some implementations, the recommendation system can be installed on a centralized computing system and an assistant can connect to or otherwise interface with the centralized computing system using a portable computing device.

The recommendation system can interface with a centralized transaction database and with a display device included in the portable computing device. The recommendation system can access data included in the centralized transaction database for the retailer that includes information about items the retailer offers for sale. The recommendation system can identify items that the retailer sells that are similar to the item selected by the customer for purchase using a similarity algorithm that can calculate a similarity between the features of the candidate items and the selected item. The recommendation system can find items that the retailer sells that are related to the item selected by the customer for purchase using a related-items algorithm that can calculate a support factor and confidence factor for the relationship between the selected item and a candidate related item. The recommendation system can take the recommended candidate similar and/or related items and determine an average expected profit for various combinations of possible customer purchases. The recommendation system can sort or rank the average expected profits and present each sales combination along with its associated average expected profit to the assistant on a display device included in the portable computing device.

Using the recommendation system, the assistant can make appropriate recommendations to the customer for other items the customer may also be interested in purchasing. The appropriate recommendations can fulfil the needs of the customer while maximizing a profit for the retail store for the sale. The centralized transaction database for the retailer can store data and information for a large number of items whose prices may change frequently. A recommendation system can handle a large number of items when determining the appropriate recommendations. The use of a recommendation system reduces the need for a skilled assistant. Example retail stores/locations that can benefit from the use of a recommendation system can be chain pharmacies, supermarkets, shopping malls and other large retailers that have for sale a large number of items.

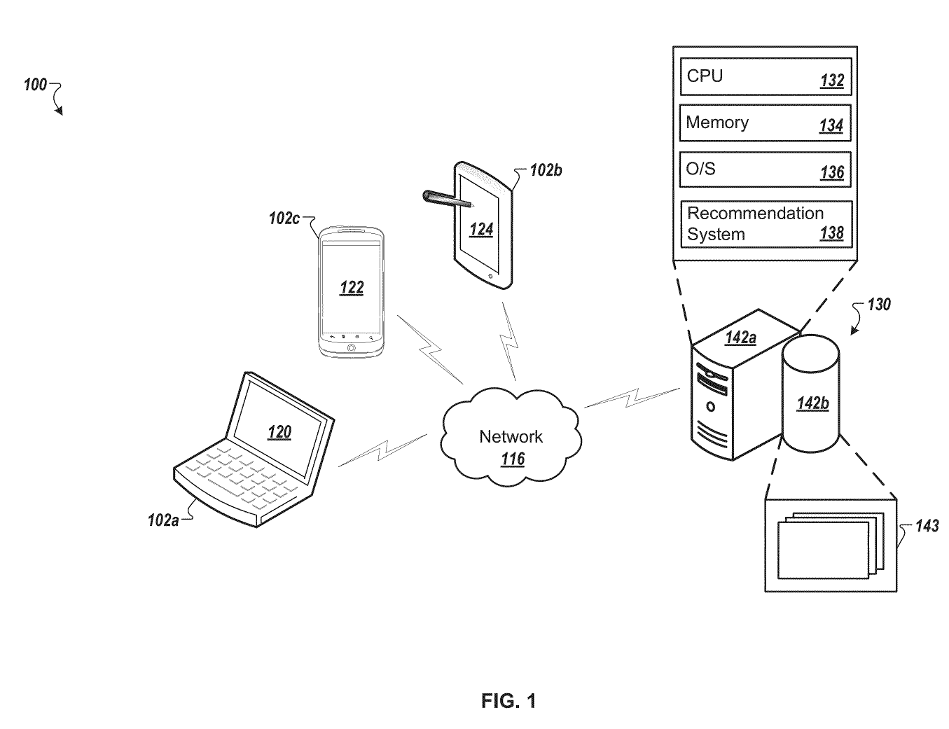

FIG. 1 is a diagram of an example system 100 that includes a recommendation system 138 installed on a centralized computer system 130. In some implementations, the centralized computer system 130 can be located remotely from a retail store. In these implementations, a retailer may have multiple locations (stores) that can access the remote centralized computer system 130.

The example system 100 includes computing devices 102a-c. An assistant located in a retail store can connect to or otherwise interface with the centralized computing system 130 by way of a network 116 using the computing devices 102a-c (e.g., a portable computing device). For example, computing device 102a can be a mobile phone, a smartphone, a personal digital assistant, or other type of mobile computing device. The computing device 102a includes a display device 120. For example, computing device 102b can be a laptop or notebook computer. The computing device 102b includes a display device 124. For example, computing device 102c can be a tablet computer. The computing device 102c includes a display device 122. A user of the computing devices 102a-c can use/interface with the display devices 120, 124, and 122, respectively, when entering data about an item for sale into the computing devices 102a-c.

In some implementations, the network 116 can be a public communications network (e.g., the Internet, cellular data network, dialup modems over a telephone network) or a private communications network (e.g., private LAN, leased lines). In some implementations, the computing devices 102a-c can communicate with the network 116 using one or more high-speed wired and/or wireless communications protocols (e.g., 802.11 variations, WiFi, Bluetooth, Transmission Control Protocol/Internet Protocol (TCP/IP), Ethernet, IEEE 802.3, etc.).

The centralized computer system 130 can include one or more computing devices (e.g., a server 142a) and one or more computer-readable storage devices (e.g., a transaction database 142b). The transaction database 142b can include transaction records 143. The server 142a can include one or more processors (e.g., server CPU 132), and one or more memory devices (e.g., server memory 134). The computing devices 102a-c can communicate with the computer system 130 (and the computer system 130 can communicate with the computing devices 102a-c) using the network 116. The server 142a can execute a server O/S 136, and one or more applications included in the recommendation system 138. In some implementations, the computer system 130 can represent multiple computing devices (e.g., servers) and multiple computer-readable storage devices (e.g., databases) working together to perform server-side operations.

A transaction database 142b includes records for items available for sale by the retailer. Each record includes data and information associated with a specific item. The data and information can include, but is not limited to, an item identification number (e.g., a Universal Product Code (UPC)), a description of features of the item, a general description of the item, and the current cost of the item.

In the example system 100, an assistant located in the retail store can connect to or otherwise interface with the computing system 130 by way of the network 116 using the computing devices 102a-c (e.g., a portable computing device). The assistant can run the recommendation system 138 on the server 142a. The server 142a can access the transaction database 142b obtain the transaction data needed by the recommendation system 138. The recommendation system 138 can process the transaction data and provide the assistant with one or more appropriate recommendations for the customer for other items the customer may also be interested in purchasing.

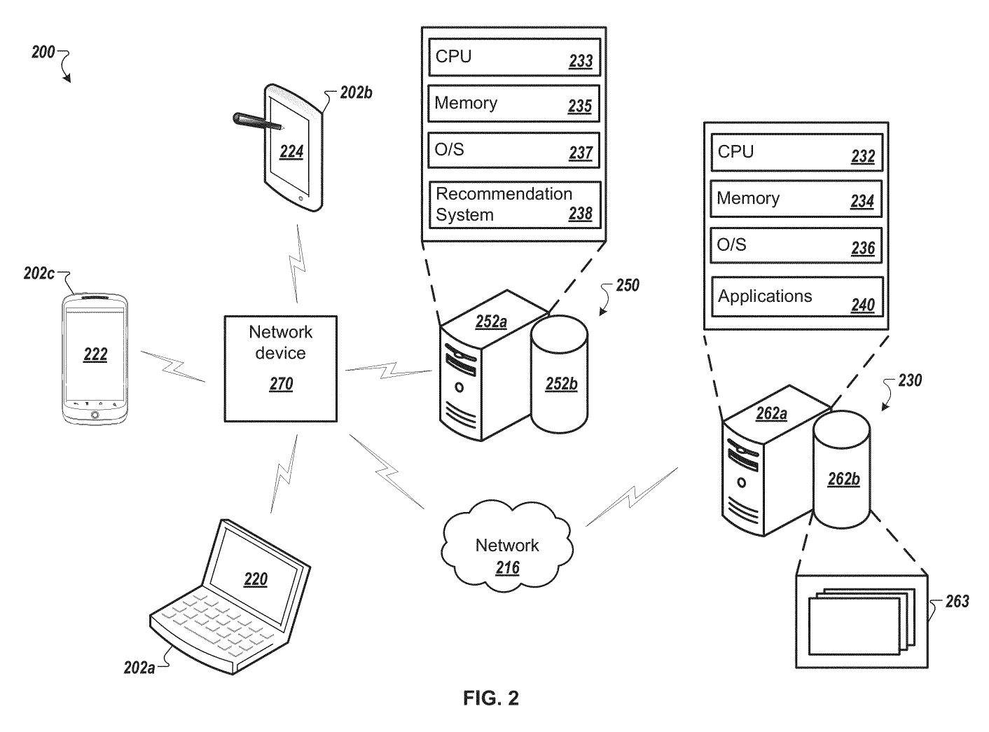

FIG. 2 is a diagram of an example system 200 that includes a recommendation system 238 installed on a computer system 250. In some implementations, the computer system 250 can be located in a specific location (e.g., an office, a storeroom) of a retail store. In addition, the computer system 250 can communicate with a remote computer system 230 (and the remote computer system 230 can communicate with the computer system 250) using a network 216.

The computer system 250 can include one or more computing devices (e.g., a server 252a) and one or more computer-readable storage devices (e.g., a database 252b). The server 252a can include one or more processors (e.g., server CPU 233), and one or more memory devices (e.g., server memory 235). Computing devices 202a-c can communicate with the computer system 250 (and the computer system 250 can communicate with the computing devices 202a-c) using a network device 270. The network device 270 can be capable of communications with the remote computer system 230 using the network 216. For example, the network device 270 can be a router, a cable modem, a digital subscriber loop (DSL) modem or other type of modem. The server 252a can execute a server O/S 237, and one or more applications included in the recommendation system 238.

The remote computer system 230 can include one or more computing devices (e.g., a server 262a) and one or more computer-readable storage devices (e.g., a transaction database 262b). The transaction database 262b can include transaction records 263. The server 262a can include one or more processors (e.g., server CPU 232), and one or more memory devices (e.g., server memory 234). The server 262a can execute a server O/S 236, and one or more server applications 240. In some implementations, the computer system 230 can represent multiple computing devices (e.g., servers) and multiple computer-readable storage devices (e.g., databases) working together to perform server-side operations.

In some implementations, the network 216 can be a public communications network (e.g., the Internet, cellular data network, dialup modems over a telephone network) or a private communications network (e.g., private LAN, leased lines). In some implementations, the computer system 250 can communicate with the network 216 by way of the network device 270. The network device 270 can communicate with/interface to the network 216 using one or more high-speed communications protocols (e.g., Transmission Control Protocol/Internet Protocol (TCP/IP), Ethernet, IEEE 802.3, etc.).

For example, computing device 202a can be a mobile phone, a smartphone, a personal digital assistant, or other type of mobile computing device. The computing device 202a includes a display device 220. For example, computing device 202b can be a laptop or notebook computer. The computing device 202b includes a display device 224. For example, computing device 202c can be a tablet computer. The computing device 202c includes a display device 222. A user of the computing devices 202a-c can use/interface with the display devices 220, 224, and 222, respectively, when entering data about an item for sale into the computing devices 202a-c.

The computing devices 202a-c can communicate wirelessly with the network device 270 using at least one type of wireless interface. Types of wireless interfaces can include, but are not limited to, WiFi (IEEE 802.11), Bluetooth, Bluetooth Low Energy (LE), and wireless infrared communications (IrDA). The type of wireless interface used can be based on a proximity of the computing device 202a-c to the network device 270.

A transaction database 262b includes records for items available for sale by the retailer. Each record includes data and information associated with a specific item. The data and information can include, but is not limited to, an item identification number (e.g., a UPC), a description of features of the item, a general description of the item, and the current cost of the item.

In the example system 200, an assistant located in the retail store can connect to or otherwise interface with the computing system 250 by way of the network device 270 using the computing devices 202a-c (e.g., a portable computing device). The assistant can run the recommendation system 138 on the server 252a. The server 252a can access the transaction database 262b included in the remote computer system 230 by way of the network device 270 and the network 216 in order to obtain the transaction data needed by the recommendation system 238. The recommendation system 138 can process the transaction data and provide the assistant with one or more appropriate recommendations for the customer for other items the customer may also be interested in purchasing.

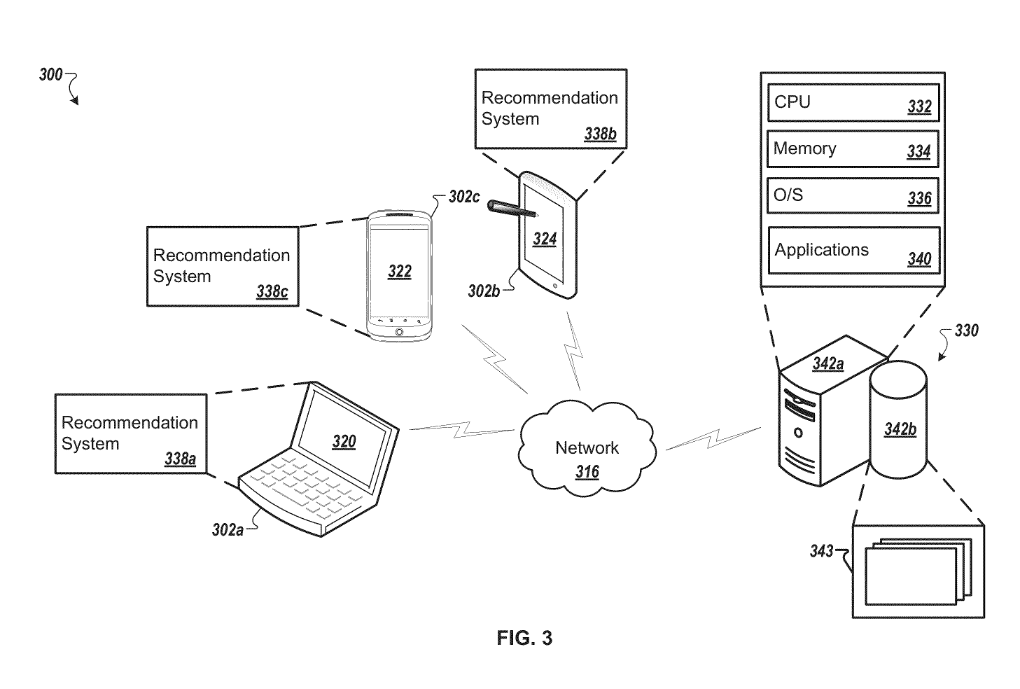

FIG. 3 is a diagram of an example system 300 that includes a copy of a recommendation system installed on each computing device 302a-c (recommendation system 338a-c, respectively). The computing devices 302a-c can be used by assistants in a retail store. In addition, the system 300 includes a centralized computer system 330 that can be located remotely from the retail store.

An assistant located in the retail store can connect to or otherwise interface with the centralized computing system 330 by way of a network 316 using any of the computing devices 302a-c (e.g., a portable computing device). For example, computing device 302a can be a mobile phone, a smartphone, a personal digital assistant, or other type of mobile computing device. The computing device 302a includes a display device 320. For example, computing device 302b can be a laptop or notebook computer. The computing device 302b includes a display device 324. For example, computing device 302c can be a tablet computer. The computing device 302c includes a display device 322. A user of the computing devices 302a-c can use/interface with the display devices 320, 324, and 322, respectively, when entering data about an item for sale into the computing devices 302a-c.

In some implementations, the network 316 can be a public communications network (e.g., the Internet, cellular data network, dialup modems over a telephone network) or a private communications network (e.g., private LAN, leased lines). In some implementations, the computing devices 302a-c can communicate with the network 316 using one or more high-speed wired and/or wireless communications protocols (e.g., 802.11 variations, WiFi, Bluetooth, Transmission Control Protocol/Internet Protocol (TCP/IP), Ethernet, IEEE 802.3, etc.).

The centralized computer system 330 can include one or more computing devices (e.g., a server 342a) and one or more computer-readable storage devices (e.g., a transaction database 342b). The transaction database 342b can include transaction records 343. The server 342a can include one or more processors (e.g., server CPU 332), and one or more memory devices (e.g., server memory 334). The computing devices 302a-c can communicate with the computer system 330 (and the computer system 330 can communicate with the computing devices 302a-c) using the network 316. The server 342a can execute a server O/S 336, and one or more applications 340. In some implementations, the computer system 330 can represent multiple computing devices (e.g., servers) and multiple computer-readable storage devices (e.g., databases) working together to perform server-side operations.

A transaction database 342b includes records for items available for sale by the retailer. Each record includes data and information associated with a specific item. The data and information can include, but is not limited to, an item identification number (e.g., a UPC), a description of features of the item, a general description of the item, and the current cost of the item.

In the example system 300, an assistant located in the retail store can connect to or otherwise interface with the computing system 330 by way of the network 316 using the computing devices 302a-c (e.g., a portable computing device). The assistant can run a local version of a recommendation system on the computing device 302a-c (recommendation system 338a-c, respectively). The computing device 302a-c can access the server 342a in order to gain access to the transaction database 342b to obtain the transaction data needed by the local version of the recommendation system. The recommendation system (e.g., recommendation system 338a, recommendation system 3 338b, or recommendation system 338c) can process the transaction data and provide the assistant with one or more appropriate recommendations for the customer for other items the customer may also be interested in purchasing.

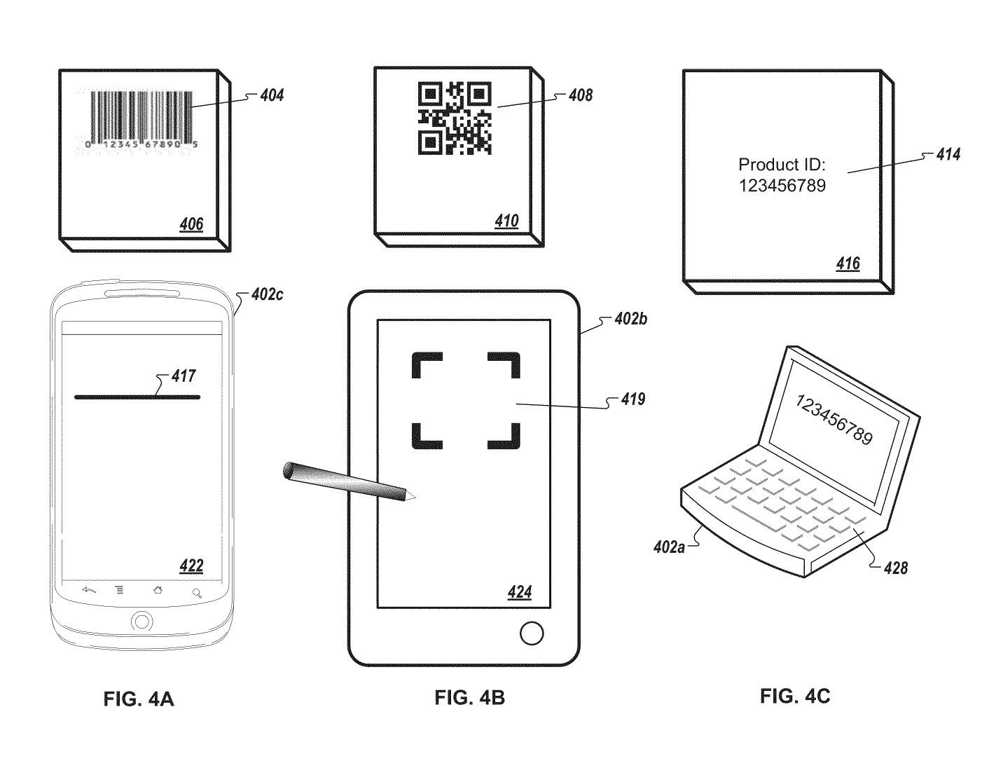

FIGS. 4A-C are diagrams showing example ways information associated with an item can be entered into a computing device for use by a recommendation system. Though certain means are shown with respect to particular computing devices, the means for entering the information for the item can be performed on a number of different computing devices as described herein.

FIG. 4A is a diagram showing a 2D bar code 404 (e.g., a UPC) included on an item 406. A customer decides to purchase the item 406. An assistant, using the computing device 402c, can scan the 2D bar code 404. In some implementations, the computing device 402c can include a bar code scanner and bar code scanning software that are capable of scanning bar codes and interpreting the bar code data. In some implementations, the computing device 402c can include bar code software that operates in conjunction with hardware already included on the computing device 402c such as a camera and auxiliary strobe or other source of auxiliary lighting. A display device 422 included in the computing device 402a can display an indicator 417. While the computing device 402c is in a scanning mode of operation, a user can hold/place the computing device 402c over the 2D bar code 404 while viewing the 2D bar code on the display device 422, aligning the indicator 417 over the 2D bar code 404. The user can interact with the computing device 402c (e.g., press a button, touch an icon on a touch-sensitive surface of the display device 422) to initiate the capture of the 2D bar code data on the computing device 402c.

The 2D bar code 404 can include an identification number for the item 406. Referring to FIG. 1, for example, the computing device 102c can provide the data representative of the scanned 2D bar code 404 to the computer system 130. The server 142a can access the transaction database 142b using the identification number for the item 406 encoded in the data representative of the scanned 2D bar code 404 to determine additional information and data associated with the item 406. The additional information and data can include, but is not limited to, a cost associated with the item 406, identification numbers (or other type of identifier) for one or more items for possible cross-selling, and identification numbers (or other type of identifier) for one or more items for possible up-selling. The additional information and data can be provided to the recommendation system 138 for use in determining one or more appropriate recommendations for the customer for other items the customer may also be interested in purchasing.

Referring to FIG. 2, the computing device 202c can provide the data representative of the scanned 2D bar code 404 to the computer system 250. The server 252a can access the computing system 230. The server 262a can access the transaction database 262b using the identification number for the item 406 encoded in the data representative of the scanned 2D bar code 404 to determine additional information and data associated with the item 406. The additional information and data can be provided to the computing system 250 for use by the recommendation system 238 when determining one or more appropriate recommendations for the customer for other items the customer may also be interested in purchasing.

Referring to FIG. 3, the computing device 302c can provide the data representative of the scanned 2D bar code 404 to the computer system 330. The server 342a can access the transaction database 342b using the identification number for the item 406 encoded in the data representative of the scanned 2D bar code 404 to determine additional information and data associated with the item 406. The additional information and data can be provided to the recommendation system 338b for use in determining one or more appropriate recommendations for the customer for other items the customer may also be interested in purchasing.

FIG. 4B is a diagram showing a 3D bar code 408 (e.g., a QR code) included on an item 410. A customer decides to purchase the item 410. An assistant, using the computing device 402b, can scan the 3D bar code 408. In some implementations, the computing device 402b can include a bar code scanner and bar code scanning software that are capable of scanning bar codes and interpreting the bar code data. In some implementations, the computing device 402b can include bar code software that operates in conjunction with hardware already included on the computing device 402b such as a camera and auxiliary strobe or other source of auxiliary lighting. A display device 424 included in the computing device 402b can display an indicator 419. While the computing device 402b is in a scanning mode of operation, a user can hold/place the computing device 402b over the 3D bar code 408 while viewing the 3D bar code on the display device 424, aligning the indicator 419 over the 3D bar code 408. The user can interact with the computing device 402b (e.g., press a button, touch an icon on a touch-sensitive surface of the display device 424) to initiate the capture of the 3D bar code data on the computing device 402b.

The 3D bar code 408 can include an identification number for the item 410. Referring to FIG. 1, for example, the computing device 102b can provide the data representative of the scanned 3D bar code 408 to the computer system 130. The server 142a can access the transaction database 142b using the identification number for the item 410 encoded in the data representative of the scanned 3D bar code 408 to determine additional information and data associated with the item 406. The additional information and data can include, but is not limited to, a cost associated with the item 410, identification numbers (or other type of identifier) for one or more items for possible cross-selling, and identification numbers (or other type of identifier) for one or more items for possible up-selling. The additional information and data can be provided to the recommendation system 138 for use in determining one or more appropriate recommendations for the customer for other items the customer may also be interested in purchasing.

Referring to FIG. 2, the computing device 202b can provide the data representative of the scanned 3D bar code 408 to the computer system 250. The server 252a can access the computing system 230. The server 262a can access the transaction database 262b using the identification number for the item 410 encoded in the data representative of the scanned 3D bar code 408 to determine additional information and data associated with the item 410. The additional information and data can be provided to the computing system 250 for use by the recommendation system 238 when determining one or more appropriate recommendations for the customer for other items the customer may also be interested in purchasing.

Referring to FIG. 3, the computing device 302b can provide the data representative of the scanned 3D bar code 408 to the computer system 330. The server 342a can access the transaction database 342b using the identification number for the item 406 encoded in the data representative of the scanned 3D bar code 408 to determine additional information and data associated with the item 410. The additional information and data can be provided to the recommendation system 338b for use in determining one or more appropriate recommendations for the customer for other items the customer may also be interested in purchasing.

Referring to FIGS. 4A and 4B, an application running on the computing device 402b and on the computing device 402c can provide the functionality and interface for enabling the scanning of the 2D bar code 404 an the 3D bar code 408, respectively. In some implementations, the same application may be capable of scanning both the 2D bar code 404 and the 3D bar code 408. In some implementations, a different application may be used to scan the 2D bar code 404 and the 3D bar code 408. In some implementations, a camera included in the computing device 402b and a camera included in the computing device 402c can be used to scan the 2D bar code 404 and the 3D bar code 408, respectively. In some implementations, one or both of the computing device 402b and on the computing device 402c can include hardware for scanning bar codes.

FIG. 4C is a diagram showing a product identification (ID) 414 included on an item 416. A customer decides to purchase the item 416. An assistant, using the computing device 402a, can enter the product ID 414 using a keyboard 428 included in the computing device 402a. The example in FIG. 4C shows a numerical product ID, however, in some implementations the product ID can include both alpha and numeric characters. In some implementations, the product ID can be alpha characters. Referring to FIG. 1, for example, the computing device 102a can provide the entered product ID 414 to the computer system 130. The server 142a can access the transaction database 142b using the product ID 414 (an identification number for the item 416) to determine additional information and data associated with the item 416. The additional information and data can include, but is not limited to, a cost associated with the item 416, identification numbers (or other type of identifier) for one or more items for possible cross-selling, and identification numbers (or other type of identifier) for one or more items for possible up-selling. The additional information and data can be provided to the recommendation system 138 for use in determining one or more appropriate recommendations for the customer for other items the customer may also be interested in purchasing.

Referring to FIG. 2, the computing device 202a can provide the entered product ID 414 to the computer system 250. The server 252a can access the computing system 230. The server 262a can access the transaction database 262b using the product ID 414 to determine additional information and data associated with the item 416. The additional information and data can be provided to the computing system 250 for use by the recommendation system 238 when determining one or more appropriate recommendations for the customer for other items the customer may also be interested in purchasing.

Referring to FIG. 3, the computing device 302b can provide the entered product ID 414 to the computer system 330. The server 342a can access the transaction database 342b using the product ID 414 to determine additional information and data associated with the item 416. The additional information and data can be provided to the recommendation system 338b for use in determining one or more appropriate recommendations for the customer for other items the customer may also be interested in purchasing.

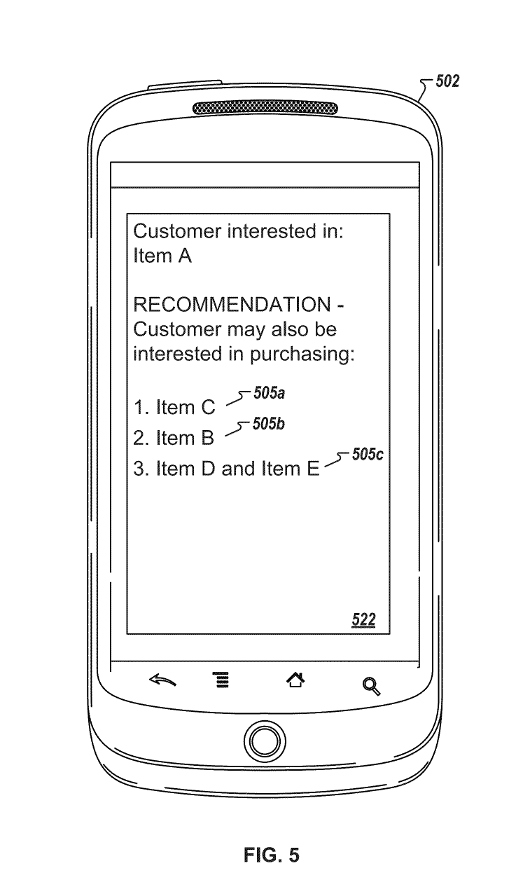

FIG. 5 is an illustration of an example computing device 502 that shows appropriate recommendations 505a-c for up-selling or cross-selling to a customer. As described herein, a recommendation system can provide an assistant in a retail store with one or more appropriate recommendations for a customer for other items the customer may also be interested in purchasing. In the example of FIG. 5, a display device 522 included in the computing device 502 displays information (e.g., an item 507 that the customer is interested in purchasing and recommendations 505a-c) for use by the assistant when making cross-selling and/or up-selling recommendations to a customer.

The example computing device 502 can be any of the computing devices discussed herein. For example, the computing device 502 can be used in the systems 100, 200 and 300 described herein. In the example implementation shown in FIG. 5, the recommendations 505a-c are displayed as an ordered list, where the best/preferred recommendation 505a is first on the list. In other implementations, the recommendations 505a-c can be displayed in a different format, such as a table or chart. In some implementations, the recommendations can be included in/presented in a report. In some implementations, the presentation of the recommendations can include pictures.

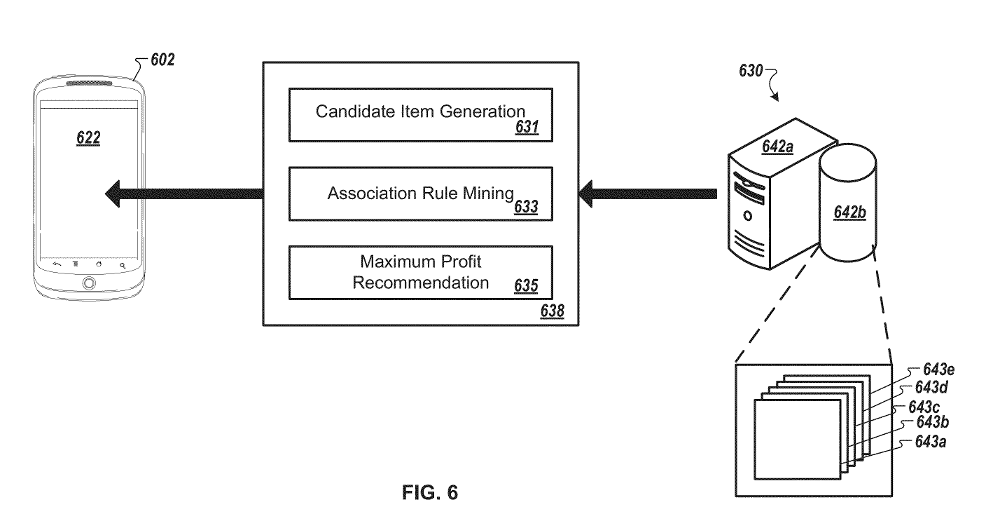

FIG. 6 is an illustration showing modules 631, 633, and 635 that are included in a recommendation system 638. The recommendation system 638 can be any of the recommendation systems described herein. As described with reference to FIG. 1, the recommendation system 638 can be included in a centralized computer system (e.g., the recommendation system 138 included in the server 142a). As described with reference to FIG. 2, the recommendation system 638 can be included in a computer system located within a retail store (e.g., the recommendation system 238 included in the server 252a). As described with reference to FIG. 3, a recommendation system (e.g., the recommendation system 638) can be included in each computing device 302a-c (e.g., in each portable handheld device for use by an assistant).

The recommendation system 638 includes a candidate item generation module 631, an association rule mining module 633, and a maximum profit recommendation module 635. The recommendation system 638 receives transaction information and data from a transaction database 642b included in a computer system 630 that also includes a server 642a. The recommendation system 638 provides appropriate recommendations for the customer for other items the customer may also be interested in purchasing for output in a format for display on a display device 622 included in a computing device 602.

In some implementations, the transaction database 642b can be an in-memory, column orientated, relational database. In some implementations, the transaction database 642b can be a relational database.

For example, an assistant located in a retail store can try to cross-sell or up-sell an item selected by a customer. The assistant can use the computing device 602 to access and run the recommendation system 638. Examples of such interactions were described with reference to FIGS. 1, 2, and 3. The assistant can enter a product code (e.g., a UPC) for an item selected for purchase by a customer into the computing device 602.

With reference to FIGS. 4A-C, in some implementations, the computing device 602 can be configured to scan a bar code included on the item. The bar code provides an optical representation of data (a product number) related to/associated with the item. In these implementations, an assistant can hold a portable computing device in a hand or can otherwise easily carry the portable computing device with them as they walk the sales floor of a retail store, interacting with customers. When a customer selects an item to purchase, the assistant can enter data identifying the selected item (e.g., a bar code, a product identification number) into the portable computing device using one or more input devices included in the portable computing device. For example, the portable computing device can scan the bar code on the selected item. In another example, the assistant can manually enter a bar code or other type of product identification number or code into the portable computing device using a keyboard or touchscreen included in the portable computing device. In addition or in the alternative, the assistant can manually enter the name of the product along with any other pertinent information about the item (e.g., weight, color, size). In yet another example, the assistant may be able to speak the information about the product into a speaker included in the portable computing device. Using voice recognition software, the portable computing device can identify (or otherwise generate information/data that can be used by the recommendation system to identify) the selected item.

The recommendation system 638 can access data included in the centralized transaction database 642b for a retailer that includes information about items the retailer offers for sale. The candidate item generation module 631 included in the recommendation system 638 can identify items that the retailer sells that are similar to the item selected by the customer for purchase using a similarity algorithm that can calculate a similarity between the features of the candidate items and the selected item. For example, if a customer wants to purchase a particular mobile phone, the recommendation system can identify other mobile phones with similar features.

In a first implementation, a cosine similarity can be used as a measure of similarity between two items. Equation 1 can be used to calculate a cosine similarity, s (p₁, p₂), between items p₁ and p₂.

$$s ( {p}_{1} , {p}_{2} ) = \frac{{\sum }_{i = 1}^{n} {f}_{i}^{{p}_{1}} * {f}_{i}^{{p}_{2}}}{\sqrt{{\sum }_{i = 1}^{n} {( {f}_{i}^{{p}_{1}} )}^{2} * \sqrt{{\sum }_{i = 1}^{n} {( {f}_{i}^{{p}_{2}} )}^{2}}}} \qquad Equation 1$$

where i is the number of features, fᵢ^{p}^{₁} is the i^{th} feature of item p₁, and fᵢ^{p}^{₂} is the i^{th} feature of item p₂.

In a second implementation, a squared Euclidean distance can be used as a measure of similarity between two items. Equation 2 can be used to calculate a squared Euclidean distance, d (p₁, p₂), between items p₁ and P₂.

d(p₁,p₂)=\sqrt{Σᵢ₌₁ⁿ(fᵢ^{p}^{₁}−fᵢ^{p}^{₂})²} Equation 2:

where i is the number of features, fᵢ^{p}^{₁} is the i^{th} feature of item pᵢ, and fᵢ^{p}^{₂} is the i^{th} feature of item p₂.

In a third implementation, a Jaccard index can be used as a measure of similarity between two items. Equation 3 can be used to calculate a Jaccard index, d(p₁,p₂), between items p₁ and P₂.

$$j ( {p}_{1} , {p}_{2} ) = \frac{{F}^{{p}_{1}} ⋂ {F}^{{p}_{2}}}{{F}^{{p}_{1}} ⋃ {F}^{{p}_{2}}} \qquad Equation 3$$

where i is the number of features, F^{p}^{₁} is the feature set of item p₁, and F^{p}^{₂} is the feature set of item p₂.

A retailer can select one of the three implementations to use to determine a measured similarity between two items. The selection of the implementation can be made based on which implementation produces the best results for the retailer. For example, the first implementation uses a cosine similarity to determine a measured similarity between two items. The first implementation may produce the best results for the retailer, however, calculating a cosine similarity can be time and computationally intensive. In this case, the selection of the second or third implementation may be a better choice.

For example, a cold medication can be used to treat multiple cold symptoms, such as a cough, a fever, and a runny nose. Each symptom a cold medication can treat can be considered a feature of the medication. The symptoms can be a cough, a runny nose, and a fever. The symptoms can be considered features of the cold medication item.

Table 1 shows four different cold medications: Medicine 1, Medicine 2, Medicine 3, and Medicine 4, their associated features: cough, fever, and runny nose, and a cost for each medicine.

TABLE 1

| | Cough | Fever | Runny Nose | Price |
|---|---|---|---|---|
| Medicine 1 | ✓ | ✓ | ✓ | $15 |
| Medicine 2 | ✓ | ✓ | | $9 |
| Medicine 3 | | ✓ | ✓ | $10 |
| Medicine 4 | ✓ | | | $12 |

Based on its features (or functions), each medicine can be represented as a vector with a binary value for each feature. For example, a binary vector value equal to “1” indicates the medicine includes (provides) the feature. A binary vector value equal to “0” indicates the medicine does not include (provide) the feature. Based on the information in Table 1, Medicine 1 (mᵢ) can be represented as m₁=(1,1,1). Similarly, Medicine 2 can be represented as m₂=(1,1,0), Medicine 3 can be represented as m₃=(0,1,1), and Medicine 4 can be represented as m₂=(1,0,0). A calculated cosine similarity between Medicine 1 and Medicine 2 is equal to 0.8165. Table 2 shows calculated cosine similarities between the medicines: Medicine 1, Medicine 2, Medicine 3, and Medicine 4. Table 2 shows a cosine similarity matrix between the medicines Medicine 1, Medicine 2, Medicine 3, and Medicine 4.

TABLE 2

| | Medicine 1 | Medicine 2 | Medicine 3 | Medicine 4 |
|---|---|---|---|---|
| Medicine 1 | 1 | 0.8165 | 0.8165 | 0.5774 |
| Medicine 2 | 0.8165 | 1 | 0.5 | 0.7071 |
| Medicine 3 | 0.8165 | 0.5 | 1 | 0 |
| Medicine 4 | 0.5774 | 0.7071 | 0 | 1 |

The candidate item generation module 631 can use a selected one of the implementations for calculating a similarity between items: the first implementation that calculates a cosine similarity matrix as a measure of similarity between items, the second implementation that calculates a squared Euclidean distance as a measure of similarity between items, or the third implementation that calculates a Jaccard index as a measure of similarity between items. The calculated measures of similarity between items can result in, as shown in the example of Table 2, candidate pairs of similar items.

A minimum threshold can be applied to each calculated similarity for each candidate pair in order to determine a similarity level that above which two items will be considered “similar”. For example, applying a minimum threshold of 0.7 to the similarity results in Table 2 results in determining that Medicine 1 and Medicine 2 are similar, Medicine 1 and Medicine 3 are similar, and Medicine 2 and Medicine 4 can be considered similar items. As shown in the example in Table 2, increasing the threshold level (e.g., setting the threshold level to 0.8) can decrease the number of pairs of similar items. As shown in the example in Table 2, decreasing the threshold level (e.g., setting the threshold level to 0.5) can increase the number of pairs of similar items. A retailer, therefore, by adjusting the threshold level can adjust the number of pairs of items included in a set of similar items.

The recommendation system 638 can find items that the retailer sells that are related to the item selected by the customer for purchase. The association rule mining module 633 can use (follow) one or more association rule mining algorithms (related-items algorithms) to calculate a support factor (a support score) and a confidence factor (a confidence score) for a relationship between the selected item and a candidate related item. The association rule mining algorithms can identify interesting relationships between items included in the transaction database 642b. For example, if a customer wants to purchase a particular mobile phone, the recommendation system 638 can identify one or more related items (e.g., a car charger, ear buds, an external case) that the customer may be interested in purchasing along with the purchase of the mobile phone.

Example association rule mining algorithms (related-items algorithms) that can be used can include, but are not limited to, Apriori algorithms, Equivalent Class Transformation (Eclat) algorithms, and Frequent Pattern growth (FP-Growth) algorithms.

Table 3 shows five transactions (Transaction ID1 to Transaction ID5). Each transaction (Transaction ID1 to Transaction ID5) can be stored as a transaction record 643a-e in the transaction database 642b.

TABLE 3

| Transaction | Orange | | Cream | |
|---|---|---|---|---|
| ID | Juice | Bagels | Cheese | Wine |
| 1 | 1 | 1 | 0 | 0 |
| 2 | 0 | 0 | 1 | 0 |
| 3 | 0 | 0 | 0 | 1 |
| 4 | 1 | 1 | 1 | 0 |
| 5 | 0 | 1 | 0 | 0 |

An association rule between bagels and orange juice as shown in Table 3 can be expressed in a format shown in Example 1.

### Example 1

{bagels}=>{orange juice} with support=⅖=0.4 and confidence=0.67

Referring to Table 3, for the five transactions ID1 to ID5, for two of the five transactions (⅖ths, 0.4, or 40% of the transactions) a customer bought orange juice and bagels together (at the same time, in the same transaction). In addition, if a customer buys orange juice, 67% of the customers will also buy bagels in the same transaction. Referring to Table 3, three transactions involved a customer purchasing bagels and two of the three transactions (67% of the transactions) where a customer bought bagels they also bought orange juice in the same transaction.

Below are examples of other association rules that can be mined by the association rule mining module 633.

### Example 2

{orange juice, bagels}=>{cream cheese} with support=⅕=0.2 and confidence=½=0.5

Referring to Table 3, for the five transactions ID1 to ID5, a customer bought both orange juice and bagels in two of the transactions (transaction ID1 and transaction ID 4). In the transaction ID 4, the customer also bought cream cheese. In one of the five total transactions the customer bought orange juice, bagels and cream cheese.

### Example 3

{orange juice, bagels}=>{wine} with support=0 and confidence=0

Referring to Table 3, for the five transactions ID1 to ID5, a customer bought both orange juice and bagels in two of the transactions (transaction ID1 and transaction ID 4). In none of the transactions ID 1 to ID 5 did the customer also buy wine. In none of the five total transactions did the customer buy orange juice, bagels and wine.

A threshold level can be applied to a calculated value for the support factor and a calculated value for the confidence factor for each association rule to identify related items. For example, referring to Table 3 and the transactions ID1 to ID5, a minimum support (min_support) threshold value can be set equal to 0.3 and a minimum confidence (min_confidence) threshold value can be set equal to 0.5. In this case, orange juice would be considered a related item to bagels. A customer that buys bagels would be interested in also buying orange juice.

Calculated values for support factors and calculated values for confidence factors can be different when calculated in a reverse relationship between the items. Example 4 shows the reverse relationship of bread and milk as shown in Example 1 above and the calculated value for the support factor and the calculated value for the confidence factor.

### Example 4

{orange juice}=>{bagels} with support=⅖=0.4 and confidence=1.00

Referring to Table 3, for the five transactions ID1 to ID5, for two of the five transactions (⅖ths, 0.4, or 40% of the transactions) a customer bought orange juice and bagels together (at the same time, in the same transaction). In addition, if a customer buys orange juice, 100% of the customers will also buy bagels in the same transaction. Referring to Table 3, two transactions involved a customer purchasing orange juice and in the two transactions (100% of the transactions) a customer bought both orange juice and bagels in the same transaction.

The recommendation system 638 can take the recommended candidate similar and/or related items and, using the maximum profit recommendation module 635, can determine an average expected profit for various combinations of possible customer purchases. The recommendation system 638 can sort or rank the average expected profits and present each sales combination along with its associated average expected profit to the assistant on the display device 622 included in the computing device 602. Using the recommendation system 638, the assistant can make appropriate recommendations to the customer for other items the customer may also be interested in purchasing.

In determining a maximum profit recommendation, the maximum profit recommendation module 635 can determine a probability of a customer buying a second item after choosing to buy a first item. In general, the probability can be a measurement of (or a value associated with) the likelihood of a customer buying a second item after choosing to buy a first item. The probability can be used when determining an expected profit value in a proposed up-selling recommendation to a customer (recommend selling a similar item to the customer) or in a proposed cross-selling recommendation to a customer (recommend selling a related item to the customer).

A customer who would like to/is planning to purchase an item (I) has an associated probability p_{I→A} that the customer will also purchase item A and an associated probability p_{I→B} that the customer will also purchase item B. For example, assume that the customer will either buy item A with item I or will buy item B with item (I). In addition, assume the profit of selling item A is c_{A} and the profit of selling item B is c_{B}. An expected profit of recommending selling item A with item I is E(I→A)=c_{I}+p_{I→A}*c_{A}. An expected profit of recommending selling item B with item I is E(I→B)=c_{I}+p_{I→B}*c_{B}. In general, Equation 4 can be used to calculate the expected profit of a sales recommendation as the sum of a profit that can be made from the sale of the item selected by a customer and profit(s) made by the sale of the recommended item(s).

E(Iₜ→I_{iεŝi≠t})=c_{I}+Σ*p_{I}_{^{t}}_{→I}_{ⁱ}*cᵢ Equation 4:

where Iₜ is the item selected by the customer for purchase and I_{iεŝi≠t} is a set of items that can be recommended to the customer for purchase.

Information and data included in the transaction database 642b can be used to calculate a probability that a customer who bought a particular item (e.g., item A) would also be interest in buying a recommended item (e.g., item B). Referring to Table 3 as an example, the probability that a customer who buys orange juice will also buy bagels is equal to 1. The probability that a customer who buys orange juice will also buy cream cheese is 0.5. The probability that a customer who buys orange juice will also buy wine is 0. The probability that a customer who buys wine will also buy bagels is 0. The probability that a customer who buys bagels will also buy orange juice is 0.67.

Based on the above probabilities, recommendations for selling identified similar and/or related items to the item selected by the customer can be made based on an expected profit for the sale. Sales with the highest profits can be recommended. The recommended sales can be presented to an assistant in an order related to the amount of the expected profit for the sale.

An example of pseudo code for determining/calculating the expected profit is shown below in Example 5. An expected additional profit of selling a recommended similar and/or related item is determined by multiply a profit for selling the item by a probability associated with the cross-selling/upselling of the recommended item with the selected item. In addition, the pseudo code includes a step to sort the expected profit values in descending order before presenting them to the assistant.

### Example 5

```
  /* P1: the profit of the item that customer has selected for purchase */
  /* C: the set of recommendation candidates */
  /* EP : the set of average expected profit values */
  /* PROB: the set of probability values */
  Initialization:
  EP <- 0 // all the values in EP will be set equal to zero
  FOR EACH candidate in candidate set C
    EP[candidate] = P1
    FOR EACH item in candidate
      EP[candidate] = PROB[candidate]*PROFIT[item]
    END FOR
  END FOR
  EP <- SORT(EP) // sort the average expected profit values in EP in
descending order
  RETURN EP
```

For example, a customer selects to purchase item A. If a customer is interested in purchasing item A, the probability of the customer also being interested in purchasing item B is 30%, the probability of the customer also being interested in purchasing item C is 50%, and the probability of the customer also being interested in purchasing both item D and item E is 30%. The probabilities can be determined from data and information associated with the items that is included in the transaction database 642b.

For example, assume that the expected profit from selling item A is $15, the expected profit from selling item B is $30, the expected profit from selling item C is $20, the expected profit from selling item D is $10, and the expected profit from selling item E is $15. The expected profits from the sale of each item can be determined from information and data associated with the items that is included in the transaction database 642b. The expected profits from the sale of each recommendation is listed below. Note that the expected profit includes the profit from the sale of item A along with the profit(s) from the sale of the recommended additional item(s) multiplied by the probability of actually cross-selling/up-selling the item with the selected item.

Table 4 shows the recommendation and the expected profit from the sale of the selected item and the recommended item(s).

TABLE 4

| | Item A | Item B | Item C | Item D | Item E | |
|---|---|---|---|---|---|---|
| | EP | EP | EP | EP | EP | Total |
| | Prob | Prob | Prob | Prob | Prob | EP |
| Item A => Item B | $15 | 30% × | | | | $24 |
| | | $30 | | | | |
| Item A => Item C | $15 | | 50% × | | | $25 |
| | | | $20 | | | |
| Item A => Item B | $15 | | | 30% × | 30% × | $22.50 |
| & Item E | | | | $10 | $15 | |

As shown in FIG. 5, and referring to Table 4, the appropriate recommendations 505a-c are displayed on the display device 522 in an ordered list (in order of descending profit) with the first recommendation 505a being the sale with the highest profit.

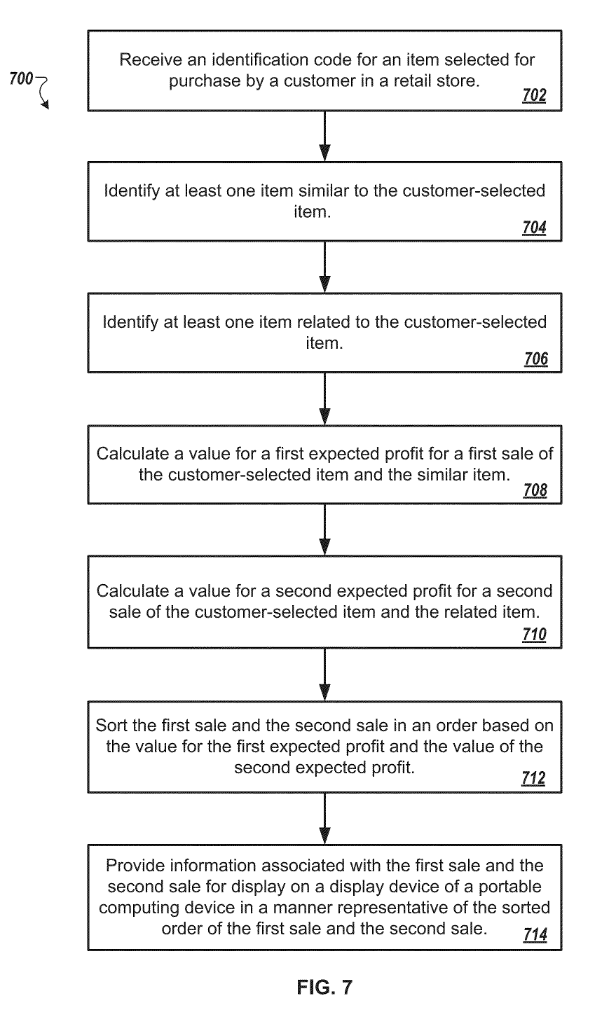

FIG. 7 is a flowchart that illustrates a method 700 for identifying cross-selling and/or upselling recommendations. In some implementations, the systems described herein can implement the method 700. For example, the method 700 can be described referring to FIGS. 1, 2, 3, 4A-C, 5, and 6.

An identification code for an item selected for purchase by a customer in a retail store is received (block 702). For example, referring to FIGS. 4A-C, an assistant can scan the 2D bar code 404 or the 3D bar code 408 using the computing device 402c and/or the computing device 402b. In another example, an assistant can enter a product ID 414 into the computing device 402a using the keyboard 428. At least one item similar to the customer-selected item is identified (block 704). For example, referring to FIG. 6, the candidate item generation module 631 performing operations using equations described herein can determine/calculate a similarity between a candidate item and the customer-selected item. At least one item related to the customer-selected item is identified (block 706). For example, referring to FIG. 6, the association rule mining module 633 can use association rule mining algorithms described herein that can determine/calculate a value for a support factor and a value for a confidence factor between a candidate item and the customer-selected item.

A value for a first expected profit for a first sale of the customer-selected item and the similar item is calculated (block 708). For example, referring to FIG. 6, the maximum profit recommendation module 635 can determine a probability of a customer buying the similar item after choosing to buy the customer-selected item. A value for a second expected profit for a second sale of the customer-selected item and the related item is calculated (block 710). For example, referring to FIG. 6, the maximum profit recommendation module 635 can determine a probability of a customer buying the related item after choosing to buy the customer-selected item. The first sale and the second sale are sorted in an order based on the value for the first expected profit and the value for the second expected profit (block 712). For example, the sale that generates the most profit can be displayed first in a list of recommended sales. Information associated with the first sale and the second sale are provided for display on a display device of a portable computing device in a manner representative of the sorted order of the first sale and the second sale (block 714). The information can be for use in recommending the similar item or the related item for purchase by the customer in the retail store. For example, referring to FIG. 5, the appropriate recommendations 505a-c are sorted such that the sale that generates the largest profit (recommendation 505a) is placed first in the list of recommendations displayed on the display device 522 included in the computing device 502.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A method comprising:
receiving an identification code for an item selected for purchase by a customer in a retail store;
identifying at least one item similar to the customer-selected item;
identifying at least one item related to the customer-selected item;
calculating a value for a first expected profit for a first sale of the customer-selected item and the similar item;
calculating a value for a second expected profit for a second sale of the customer-selected item and the related item;
sorting the first sale and the second sale in an order based on the value for the first expected profit and the value for the second expected profit; and
providing, for display on a display device of a portable computing device, information associated with the first sale and the second sale in a manner representative of the sorted order of the first sale and the second sale, the information for use in recommending the similar item or the related item for purchase by the customer in the retail store.

2. The method of claim 1, wherein identifying at least one item similar to the customer-selected item includes identifying at least one feature associated with the similar item that is the same as at least one feature associated with the customer-selected item.

3. The method of claim 1, wherein identifying at least one item similar to the customer-selected item includes calculating a value representative of the similarity between the at least one similar item and the customer-selected item.

4. The method of claim 3, wherein identifying at least one item similar to the customer-selected item further includes determining that the calculated value representative of the similarity between the at least one similar item and the customer-selected item meets or exceeds a threshold value.

5. The method of claim 3, wherein calculating a value representative of the similarity between the at least one similar item and the customer-selected item includes calculating one of a cosine similarity, a squared Euclidean distance, and a Jaccard index.

6. The method of claim 1, wherein identifying the at least one item related to the customer-selected item includes following an association rule mining algorithm that determines a value for a support factor and a value for a confidence factor for a relationship between a candidate item and the customer-selected item.

7. The method of claim 6, wherein identifying the at least one item related to the customer-selected item further includes, based on determining that the value for the support factor meets or exceeds a threshold value, identifying the candidate item as the at least one item related to the customer-selected item.

8. The method of claim 6, wherein identifying the at least one item related to the customer-selected item further includes, based on determining that the value for the support factor meets or exceeds a first threshold value and based on determining that the value for the confidence factor meets or exceeds a second threshold value, identifying the candidate item as the at least one item related to the customer-selected item.

9. The method of claim 1, wherein calculating a value for a first expected profit for a first sale of the customer-selected item and the similar item includes determining a value associated with a probability that the customer will purchase the similar item based on the selection of the customer-selected item for purchase by the customer, wherein the calculated value for the first expected profit is based on an expected profit associated with the sale of the customer-selected item, an expected profit associated with the sale of the similar item, and the value associated with the probability that the customer will purchase the similar item.

10. The method of claim 1, wherein calculating a value for a second expected profit for a second sale of the customer-selected item and the related item includes determining a value associated with a probability that the customer will purchase the related item based on the selection of the customer-selected item for purchase by the customer, wherein the calculated value for the second expected profit is based on an expected profit associated with the sale of the customer-selected item, an expected profit associated with the sale of the related item, and the value associated with the probability that the customer will purchase the related item.

11. The method of claim 1, wherein the sorted order is a descending order of the value for the first expected profit and the value for the second expected profit.

12. A system comprising:
a portable computing device including:
a display device;
a recommendation system including a candidate item generation module, an association rule mining module, and a maximum profit recommendation module; and
means for entering identification data for association with an item;
wherein the means for entering identification data for association with an item include means for entering an identification code for an item selected for purchase by a customer in a retail store;
wherein the candidate item generation module is configured to identify at least one item similar to the customer-selected item;
wherein the association rule mining module is configured to identify at least one item related to the customer-selected item;
wherein the maximum profit recommendation module is configured to:
calculate a value for a first expected profit for a first sale of the customer-selected item and the similar item;
calculate a value for a second expected profit for a second sale of the customer-selected item and the related item; and
sort the first sale and the second sale in an order based on the value for the first expected profit and the value of the second expected profit; and
wherein the display device is configured to display information associated with the first sale and the second sale in a manner representative of the sorted order of the first sale and the second sale.

13. The system of claim 12,
wherein identifying at least one item similar to the customer-selected item includes the candidate item generation module being configured to:
access a plurality of records for items available for sale by a retailer;
calculate a value representative of a similarity between a record for a candidate item and a record for the customer-selected item; and
identify the candidate item as the similar item based on determining that the calculated value meets or exceeds a threshold value.

14. The system of claim 12,
wherein identifying at least one item related to the customer-selected item includes the association rule mining module being configured to:
access a plurality of records for items available for sale by a retailer;
calculate a value for a support factor and a value for a confidence factor for a relationship between a record for a candidate item and a record for the customer-selected item; and
identify the candidate item as the related item based on determining that the calculated value for the support factor meets or exceeds a first threshold value and that the calculated value for the confidence factor meets or exceeds a second threshold value.

15. The system of claim 12, wherein calculating a value for a first expected profit for a first sale of the customer-selected item and the similar item includes the maximum profit recommendation module being configured to:
determine a value associated with a probability that the customer will purchase the similar item based on the selection of the customer-selected item for purchase by the customer, wherein the calculated value for the first expected profit is based on an expected profit associated with the sale of the customer-selected item, an expected profit associated with the sale of the similar item, and the value associated with the probability that the customer will purchase the similar item.

16. The system of claim 12, wherein calculating a value for a second expected profit for a second sale of the customer-selected item and the related item includes the maximum profit recommendation module being configured to:
determine a value associated with a probability that the customer will purchase the related item based on the selection of the customer-selected item for purchase by the customer, wherein the calculated value for the second expected profit is based on an expected profit associated with the sale of the customer-selected item, an expected profit associated with the sale of the related item, and the value associated with the probability that the customer will purchase the related item.

17. The system of claim 12, wherein the portable computing device further includes:
a bar code scanner; and
wherein the means for entering identification data include the bar code scanner.

18. The system of claim 12, wherein the portable computing device further includes:
a keyboard; and
wherein the means for entering identification data include the keyboard.

19. A computer program product, the computer program product being tangibly embodied on a non-transitory computer-readable storage medium and comprising instructions that, when executed by at least one computing device, are configured to cause the at least one computing device to:
receive an identification code for an item selected for purchase by a customer in a retail store;
identify at least one item similar to the customer-selected item;
identify at least one item related to the customer-selected item;
calculate a value for a first expected profit for a first sale of the customer-selected item and the similar item;
calculate a value for a second expected profit for a second sale of the customer-selected item and the related item;
sort the first sale and the second sale in descending order based on the value for the first expected profit and the value for the second expected profit; and
provide for display on a display device included in the at least one computing device, information associated with the first sale and the second sale in a manner representative of the sorted order of the first sale and the second sale, the information for use in recommending the similar item or the related item for purchase by the customer in the retail store.

20. The computer program product of claim 19,
wherein the instructions that are configured to cause the at least one computing device to identify at least one item similar to the customer-selected item include instructions that are configured to cause the at least one computing device to:
identify at least one feature associated with the similar item that is the same as at least one feature associated with the customer-selected item;
calculate a value representative of the similarity between the at least one similar item and the customer-selected item; and
determine that the calculated value representative of the similarity between the at least one similar item and the customer-selected item meets or exceeds a threshold value.
